(19) United States
(12) Patent Application Publication
(10) Pub. No.: US 2023/0088668 A1
(43) Pub. Date: Mar. 23, 2023

(54) METHOD FOR TRAINING A DETERMINISTIC AUTOENCODER

(71) Applicant: Robert Bosch GmbH, Stuttgart (DE)

(72) Inventors: Amrutha Saseendran, Gaertringen (DE); Kathrin Skubch, Frankfurt (DE); Margret Keuper, Mannheim (DE); Stefan Falkner, Renningen (DE)

(21) Appl. No.: 17/943,890

(22) Filed: Sep. 13, 2022

(30) Foreign Application Priority Data
Sep. 22, 2021 (DE) 10 2021 210 532.7

(51) Int. Cl. G06N 3/08; G06K 9/62

(52) U.S. Cl. CPC G06N 3/08; G06K 9/6298

(57) ABSTRACT

A computer-implemented method for training a deterministic autoencoder. The autoencoder is configured to compress sample data representing objects and subsequently to reconstruct the sample data again, wherein the autoencoder is further configured to generate data representing additional objects. The method comprises the following steps: providing training data representing objects; and training the autoencoder on the basis of the training data, wherein the training of the autoencoder takes place on the basis of a probability distribution and a loss function, and wherein the loss function has a reconstruction term and a regularization term.

### CROSS REFERENCE

The present application claims the benefit under 35 U.S.C. § 119 of German Patent Application No. DE 10 2021 210 532.7 filed on Sep. 22, 2021, which is expressly incorporated herein by reference in its entirety.

### FIELD

The present invention relates to a method for training a deterministic autoencoder and to a method for generating data representing further objects or for generating a model based on the trained deterministic autoencoder.

### BACKGROUND INFORMATION

An autoencoder is generally understood to mean an artificial neural network which is used to learn efficient encodings. The aim of an autoencoder is in particular to learn a compressed representation of a set of data and thus also to extract essential features from the data. Where applicable, such autoencoders can also be used to generate further data, for example image data, or to generate models based on these data. Furthermore, such an autoencoder usually has at least three layers, in particular: an input layer which receives input data representing or reproducing objects, for example image data; one or more significantly smaller layers for compressing the input data; and an output layer in which each neuron has the same meaning as the corresponding neuron in the input layer in order to restore or reconstruct the input data as precisely as possible.

Among other things, a distinction is made between deterministic autoencoders and variational autoencoders (VAE).

With deterministic autoencoders, encoded values or latent vectors are generated, wherein corresponding latent attributes in the input data are encoded in a deterministic manner or as individual values. If further data are to be generated by such deterministic autoencoders, an additional step of density estimation is usually necessary in order to generate data that are of high quality or as optimal as possible.

Variational autoencoders are in turn based on a probabilistic network or are configured to encode latent attributes in the input data in a probabilistic manner or as a probability distribution, which considerably simplifies the subsequent generation of further, in particular high-quality data.

Such variational autoencoders in particular provide efficient probabilistic models for learning representations of complex data distributions. Variational autoencoders are thus configured to learn a data distribution on the basis of which new data can be generated instead of classifying the data, for example. However, it is disadvantageous, among other things, that the training of such variational autoencoders is complex and difficult. Such variational autoencoders are also usually based on the assumption that the learned latent representations follow a simple unimodal or monomodal Gaussian distribution.

U.S. Patent Application Publication No. US 2017/0004397 A1 describes a computer program product which has program code of a computer program which, when executed by a processor, is configured to generate a set of sample objects using a method model, to provide method model parameters and visual features from the example objects as training data, and to train a neural autoencoder network using the training data, wherein the neural autoencoder network can be used to generate new objects.

### SUMMARY

An object of the present invention is to provide an improved method for training an autoencoder.

This object may be achieved by a method for training a deterministic autoencoder according to the features of the present invention.

Furthermore, the object may be achieved by a controller for training a deterministic autoencoder having the features of the present invention.

The object may also be achieved by a computer program having the features of the present invention and by a computer-readable data carrier having the features of the present invention.

According to one example embodiment of the present invention, this object is achieved by a method for training a deterministic autoencoder, wherein the autoencoder is configured to compress sample data representing objects and subsequently to reconstruct the sample data again, wherein the autoencoder is further configured to generate data representing additional objects. According to an example embodiment of the present invention, training data representing objects are provided and the autoencoder is trained on the basis of the training data, wherein the training of the autoencoder takes place on the basis of a probability distribution and a loss function, and wherein the loss function has a reconstruction term and a regularization term.

In this case, sample data representing objects mean data which show sample objects, for example image data. The sample objects can be, for example, objects shown in the image data, for example faces, arithmetic formulas or chemical molecules.

The loss function is further understood to mean a function on the basis of which a deviation between data reconstructed by means of the autoencoder and the corresponding originally provided or processed data is understood. A reconstruction term is understood to mean a function term which characterizes the actual error between input and output, i.e., between the originally provided data and the corresponding data reconstructed by means of the autoencoder. The regularization term is used further to regularize the latent space, that is, to make it acceptable or regular, whereby the predictive capability or generalizability of data or models generated by means of the autoencoder can be improved.

Since a deterministic autoencoder is trained here, the training of the autoencoder is much simpler and less complex than methods for training a variational autoencoder. Because both the reconstruction term and the regularization term are taken into account during training of the autoencoder, the latent space can be made acceptable, and further high-quality data which show objects can also be reliably generated on the basis of the deterministic autoencoder, without an additional step of density estimation being necessary for this purpose. Thus, a simple and efficient frame for training a deterministic autoencoder or an improved method for training a deterministic autoencoder is provided.

The trained deterministic autoencoder can subsequently be used to compress data which show objects, so that these data can also be stored on data processing systems with comparatively low storage capacities. In addition, the trained deterministic autoencoder can be used to reliably generate further data which represent objects, in particular image data or complete models, in a simple manner on the basis of a few trained sample data and without corresponding expert knowledge, which data can subsequently be processed correspondingly and can also be used for controlling the functions of a controllable system, for example. For example, image data can be generated on the basis of which highly efficient motor vehicle components, for example wheels with a particularly aerodynamic design, can be manufactured.

In one example embodiment of the present invention, the method further comprises weighting the reconstruction term and the regularization term, wherein the training of the autoencoder is based on the probability distribution, the loss function and the weightings of the reconstruction term and of the regularization term.

In this context, weighting is understood to mean the provision of the reconstruction term and of the regularization term with weightings or a determination as to which portion of the loss function is to be formed by the reconstruction term and which portion is to be formed by the regularization term.

The method can thereby be optimized for different scenarios. For example, if the individual sample data, in particular on the basis of their coordinates, are comparatively far apart, the regularization term should be weighted more. If the autoencoder is to be trained further to generate objects which have very specific attributes or to generate data characterizing these objects, it is expedient to weight the reconstruction term more during the training of the autoencoder.

The probability distribution can also be a Gaussian mixture model.

A Gaussian mixture model is understood to mean a probabilistic model which assumes that all the data points are generated from a mixture of a finite number of Gaussian distributions with unknown parameters. In particular, a Gaussian mixture model consists of a plurality of differently weighted Gaussian functions.

In this way, the regularization, that is, the predictive capability or generalizability, of data or models generated by means of the autoencoder can be increased further.

The training data can also be sensor data or data detected by a sensor.

A sensor, which is also referred to as a detector, (measured variable or measuring) pickup or (measuring) probe, is a technical component which can detect certain physical or chemical properties and/or the material nature of its surroundings qualitatively or quantitatively as a measured variable.

Thus, the conditions characterizing corresponding objects outside the actual data processing system on which the deterministic autoencoder is trained can be detected in a simple manner and taken into account during training of the machine learning algorithm. Furthermore, however, data acquired in another way and characterizing the corresponding objects can also be detected and taken into account during training of the autoencoder.

Another example embodiment of the present invention also provides a method for generating data representing further objects by a deterministic autoencoder, wherein a trained deterministic autoencoder is provided which was trained by an above-described method for training a deterministic autoencoder, and wherein data representing further objects are generated by means of the autoencoder.

Thus, an improved method for generating object data or data representing further objects is provided, with which method high-quality data can be generated similarly to variational autoencoders. Since the method is based on a deterministic autoencoder, the training of the autoencoder can already be simplified considerably compared to methods for training a variational autoencoder. Because both the reconstruction term and the regularization term are taken into account during training of the autoencoder, the latent space can be made acceptable, and further high-quality data which show objects can also be reliably generated on the basis of the deterministic autoencoder, without an additional step of density estimation being necessary for this purpose.

The trained deterministic autoencoder can again be used, for example, to reliably generate further data which represent objects, in particular image data or complete models, in a simple manner on the basis of a few trained sample data and without corresponding expert knowledge, which data can subsequently be processed correspondingly and can also be used for controlling the functions of a controllable system, for example. For example, image data can be generated on the basis of which highly efficient motor vehicle components, for example wheels with a particularly aerodynamic design, can be manufactured.

According to an example embodiment of the present invention, the method can further comprise a step of optimizing the generated data such that the objects represented in the generated data match in at least one property.

The objects represented in the generated data matching in at least one property means that the data or objects are generated in such a way that they all have the same property and in particular a property adapted to the situation in question. The optimization during the generation can take place, for example, on the basis of Bayesian optimization.

Thus, the deterministic autoencoder can be used to generate data or models adapted optimally to the situation in question, as a result of which the reliability and safety can be significantly increased during the subsequent processing of the generated data or models.

A further embodiment of the present invention also provides a controller for training a deterministic autoencoder, wherein the autoencoder is configured to compress sample data representing objects and subsequently to reconstruct the sample data again, wherein the autoencoder is further configured to generate data representing additional objects, and wherein the controller has a receiving unit for receiving training data representing objects and a training unit which is configured to train the autoencoder on the basis of the training data, and wherein the training unit is configured to train the autoencoder on the basis of a probability function and a loss function, and wherein the loss function has a reconstruction term and a regularization term.

An improved controller for training a deterministic autoencoder is thus provided. Since a deterministic autoencoder is trained here, the training of the autoencoder is much simpler and less complex than methods for training a variational autoencoder. Because both the reconstruction term and the regularization term are taken into account during training of the autoencoder, the latent space can be made acceptable, and further high-quality data which show objects can also be reliably generated on the basis of the deterministic autoencoder, without an additional step of density estimation being necessary for this purpose. Thus, the controller provides a simple and efficient frame for training a deterministic autoencoder.

In one example embodiment of the present invention, the controller further has a weighting unit which is configured to weight the reconstruction term and the regularization term, wherein the training unit is configured to train the autoencoder on the basis of the probability distribution, the loss function and the weightings of the reconstruction term and the regularization term. The controller can be optimized for different scenarios thereby. For example, if the individual sample data, in particular on the basis of their coordinates, are comparatively far apart, the regularization term should be weighted more. If the autoencoder is to be trained further to generate objects which have very specific attributes or to generate data characterizing these objects, it is expedient to weight the reconstruction term more during the training of the autoencoder.

The probability distribution can again also be a Gaussian mixture model. In this way, the regularization, that is, the predictive capability or generalizability, of data or models generated by means of the autoencoder can be increased further.

The training data can again also be sensor data or data detected by a sensor. Thus, the conditions characterizing corresponding objects outside the actual data processing system on which the deterministic autoencoder is trained can be detected in a simple manner and taken into account during training of the machine learning algorithm. Furthermore, however, data acquired in another way and characterizing the corresponding objects can also be detected and taken into account during training of the autoencoder.

A further embodiment of the present invention also provides a controller for generating data representing further objects by means of a deterministic autoencoder, wherein the controller has a receiving unit for receiving a deterministic autoencoder by an above-described controller for training a deterministic autoencoder, and a generating unit which is configured to generate data representing further objects by means of the autoencoder.

An improved controller for generating object data or data representing further objects is thus provided. Since the controller is based on a deterministic autoencoder, the training of the autoencoder can already be simplified considerably compared to training a variational autoencoder. Because both the reconstruction term and the regularization term are taken into account during training of the autoencoder, the latent space can be made acceptable, and further high-quality data which show objects can also be reliably generated on the basis of the deterministic autoencoder, without an additional step of density estimation being necessary for this purpose.

In one example embodiment of the present invention, the generating unit further has an optimizing unit which is configured to optimize the generated data such that the objects represented in the generated data match in at least one property.

The objects represented in the generated data matching in at least one property again means that the data or objects are generated in such a way that they all have the same property and in particular a property adapted to the situation in question. The optimization during the generation can take place, for example, on the basis of Bayesian optimization.

A further example embodiment of the present invention also provides a computer program having program code in order to carry out an above-described method for training a deterministic autoencoder when the computer program is executed on a computer.

A further example embodiment of the present invention also provides a computer-readable data carrier having program code of a computer program in order to carry out an above-described method for training a deterministic autoencoder when the computer program is executed on a computer.

The computer program and the computer-readable data carrier each have the advantage that they are configured to provide an improved method for training a deterministic autoencoder. Since a deterministic autoencoder is trained here, the training of the autoencoder is much simpler and less complex than methods for training a variational autoencoder. Because both the reconstruction term and the regularization term are taken into account during training of the autoencoder, the latent space can be made acceptable, and further high-quality data which show objects can also be reliably generated on the basis of the deterministic autoencoder, without an additional step of density estimation being necessary for this purpose. Thus, a simple and efficient frame for training a deterministic autoencoder is provided.

In summary, it can be concluded that the present invention provides an improved method for training a deterministic autoencoder.

The described embodiments and developments of the present invention can be combined with one another as desired.

Further possible embodiments, developments and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of example embodiments of the present invention. They illustrate embodiments and, in connection with the description, serve to explain principles and features of the present invention.

Other embodiments and many of the mentioned advantages are apparent from the figures. The illustrated elements of the figures are not necessarily shown to scale relative to one another.

FIG. 1 shows a flowchart of a method for generating data representing further objects by a deterministic autoencoder according to example embodiments of the present invention.

FIG. 2 shows a schematic block diagram of a system for generating data representing further objects by a deterministic autoencoder according to example embodiments of the present invention.

In the figures, identical reference signs denote identical or functionally identical elements, parts or components, unless stated otherwise.

### DETAILED DESCRIPTION OF EXAMPLE EMBODIMENTS

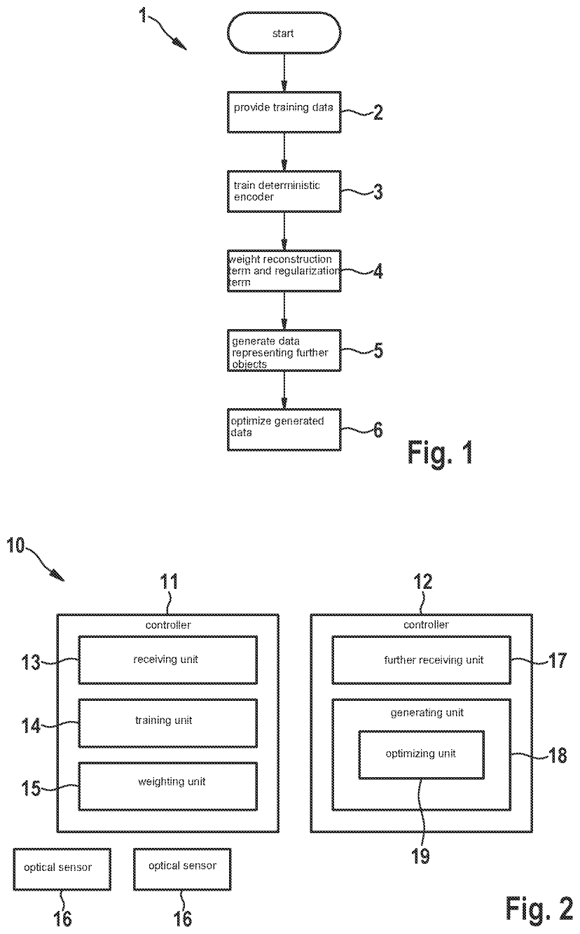

FIG. 1 shows a flowchart of a method 1 for generating data representing further objects by a deterministic autoencoder according to embodiments of the present invention.

An autoencoder is generally understood to mean an artificial neural network which is used to learn efficient encodings. The aim of an autoencoder is in particular to learn a compressed representation of a set of data and thus also to extract essential features from the data. Where applicable, such autoencoders can also be used to generate further data, for example image data, or to generate models based on these data. Furthermore, such an autoencoder usually has at least three layers, in particular: an input layer which receives input data representing or reproducing objects, for example image data; one or more significantly smaller layers for compressing the input data; and an output layer in which each neuron has the same meaning as the corresponding neuron in the input layer in order to restore or reconstruct the input data as precisely as possible.

Among other things, a distinction is made between deterministic autoencoders and variational autoencoders (VAE).

With deterministic autoencoders, encoded values or latent vectors are generated, wherein corresponding latent attributes in the input data are encoded in a deterministic manner or as individual values. If further data are to be generated by such deterministic autoencoders, an additional step of density estimation is usually necessary in order to generate data that are of high quality or as optimal as possible.

Variational autoencoders are in turn based on a probabilistic network or are configured to encode latent attributes in the input data in a probabilistic manner or as a probability distribution, which considerably simplifies the subsequent generation of further, in particular high-quality data.

Such variational autoencoders in particular provide efficient probabilistic models for learning representations of complex data distributions. Variational autoencoders are thus configured to learn a data distribution on the basis of which new data can be generated instead of classifying the data, for example. However, it is disadvantageous, among other things, that the training of such variational autoencoders is complex and difficult. Such variational autoencoders are also usually based on the assumption that the learned latent representations follow a simple unimodal or monomodal Gaussian distribution.

Variable autoencoders are usually used for example for generating image data, for sentence modeling, or for optimizing discrete data or graph-based structures.

As FIG. 1 shows, the method 1 has a step 2 of providing training data representing objects and a step 3 of training a deterministic autoencoder on the basis of the training data, wherein the training of the autoencoder takes place on the basis of a probability distribution and a loss function, and wherein the loss function has a reconstruction term and a regularization term.

Overall, FIG. 1 shows a method 1 in which the training of a deterministic autoencoder takes place in a similar way to the training of variational autoencoders, or the method for training variational autoencoders has been adapted to deterministic autoencoders. In particular, input data are converted into a latent vector with fewer dimensions than originally.

FIG. 1 thus shows an improved method for training a deterministic autoencoder. Since a deterministic autoencoder is trained here, the training of the autoencoder is much simpler and less complex than methods for training a variational autoencoder. Because both the reconstruction term and the regularization term are taken into account during training of the autoencoder, the latent space can be made acceptable, and further high-quality data which show objects can also be reliably generated on the basis of the deterministic autoencoder, without an additional step of density estimation being necessary for this purpose. Thus, a simple and efficient frame for training a deterministic autoencoder or an improved method for training a deterministic autoencoder is provided.

The training data can be in particular continuous or discrete data showing or representing individual objects, in particular image data. For example, the training data can also represent discrete and complex structures, such as arithmetic formulas or chemical molecules.

The trained deterministic autoencoder can subsequently be used to compress data which show objects, so that these data can also be stored on data processing systems with comparatively low storage capacities. In addition, the trained deterministic autoencoder can be used to reliably generate further data which represent objects, in particular image data or complete models, in a simple manner on the basis of a few trained sample data and without corresponding expert knowledge, which data can subsequently be processed correspondingly and can also be used for controlling the functions of a controllable system, for example. For example, image data can be generated on the basis of which highly efficient motor vehicle components, for example wheels with a particularly aerodynamic design, can be manufactured.

According to the embodiments of FIG. 1, the reconstruction term can correspond to a mean squared error between input data or training data and the corresponding reconstructions, that is, restorations of the input data by means of the autoencoder. The regularization term can further be based on the Kolmogorov-Smirnov (KS) test of the equality of one-dimensional probability distributions, wherein, so that the test can also be used for such deterministic autoencoders, the empirical cumulative distribution function is compared with the corresponding one-dimensional distribution function or the corresponding marginal distribution separately for each dimension, and wherein the mean from all comparative results can subsequently be calculated. In addition, the supremum in the original KS distance can optionally be replaced by a smoother loss term MSE, which compares distances between these functions, that is to say the corresponding empirical cumulative distribution functions and the marginal distributions in latent representations.

As FIG. 1 further shows, the method 1 also has a step 4 of weighting the reconstruction term and the regularization term, wherein the training of the autoencoder in step 3 is based on the probability distribution, the loss function and the weightings of the reconstruction term and the regularization term.

The method can thereby be optimized for different scenarios. For example, if the individual sample data, in particular on the basis of their coordinates, are comparatively far apart, the regularization term should be weighted more. If the autoencoder is to be trained further to generate objects which have very specific attributes or to generate data characterizing these objects, it is expedient to weight the reconstruction term more during the training of the autoencoder.

According to the embodiments of FIG. 1, the probability distribution is further a Gaussian mixture model. The use of a Gaussian mixture model additionally enables a clustering of data points.

In addition, the training data are sensor data. The sensor data can be detected, for example, by an optical sensor such as a camera, a LiDAR, a RADAR or other image and/or video data detecting optical sensors.

As FIG. 1 also shows, the method 1 further comprises a step 5 of generating data representing further objects by means of the trained deterministic autoencoder.

Thus, an improved method 1 for generating object data or data representing further objects is provided, with which method high-quality data can be generated similarly to variational autoencoders.

The illustrated method 1 further comprises a step 6 of optimizing the generated data such that the objects represented in the generated data match in at least one property.

The objects represented in the generated data matching in at least one property means that the data or objects are generated in such a way that they all have the same property and in particular a property adapted to the situation in question. The optimization during the generation can take place, for example, on the basis of Bayesian optimization.

For example, if the objects are chemical molecules, it can be ensured that all the chemical molecules and in particular also the molecules represented in the additional data all have the same property.

FIG. 2 shows a schematic block diagram of a system 10 for generating data representing further objects by a deterministic autoencoder according to embodiments of the present invention.

As FIG. 2 shows, the system 10 has a controller 11 for training a deterministic autoencoder, wherein the autoencoder is configured to compress sample data representing objects and subsequently to reconstruct the sample data again, wherein the autoencoder is further configured to generate data representing additional objects, and a controller 12 for generating data representing further objects by means of the deterministic autoencoder.

According to the embodiments of FIG. 2, the controller 11 has, for training the deterministic autoencoder, a receiving unit 13 for receiving training data representing objects and a training unit 14 which is configured to train the autoencoder on the basis of the training data, wherein the training unit 14 is configured to train the autoencoder on the basis of a probability function and a loss function, and wherein the loss function has a reconstruction term and a regularization term.

The receiving unit can be, for example, a receiver which is configured to receive the corresponding training data or sample data or sensor data. The training unit can further be implemented, for example, on the basis of code stored in a memory and executable by a processor.

As FIG. 2 shows, the controller 11 also has a weighting unit 15 which is configured to weight the reconstruction term and the regularization term, wherein the training unit 14 is configured to train the autoencoder on the basis of the probability distribution, the loss function and the weightings of the reconstruction term and of the regularization term.

The optimizing unit can in turn be implemented, for example, on the basis of code stored in a memory and executable by a processor.

The probability distribution is again a Gaussian mixture model according to the embodiments of FIG. 2.

According to the embodiments of FIG. 2, the training data are also sensor data, FIG. 2 showing optical sensors 16 for detecting the sensor data.

As FIG. 2 further shows, the controller 12 has, for generating data representing further objects by means of the deterministic autoencoder, a further receiving unit 17 for receiving the deterministic autoencoder which is trained by the controller 11 for training a deterministic autoencoder, and a generating unit 18 which is configured to generate data representing further objects by means of the autoencoder.

The receiving unit can, for example, be a receiver which is configured to receive the trained deterministic autoencoder. The generating unit can further be implemented, for example, on the basis of code stored in a memory and executable by a processor.

It can also be seen that the generating unit 18 further has an optimizing unit 19 which is configured to optimize the generated data in such a way that the objects represented in the generated data match in at least one property.

The optimizing unit can in turn be implemented, for example, on the basis of code stored in a memory and executable by a processor.

What is claimed is:

1. A method for training a deterministic autoencoder, wherein the autoencoder is configured to compress sample data representing objects and subsequently to reconstruct the sample data again, and wherein the autoencoder is further configured to generate data representing additional objects, the method comprising the following steps:
providing training data representing objects; and
training the autoencoder bases on the training data, wherein the training of the autoencoder takes place based on a probability distribution and a loss function, and wherein the loss function has a reconstruction term and a regularization term.

2. The method according to claim 1, further comprising:
weighting the reconstruction term and the regularization term;
wherein the training of the autoencoder takes place on based on the probability distribution, the loss function, and weightings of the reconstruction term and of the regularization term.

3. The method according to claim 1, wherein the probability distribution is a Gaussian mixture model.

4. The method according to claim 1, wherein the training data are sensor data.

5. A method for generating data representing further objects using a deterministic autoencoder, the method comprising the following steps:
providing a trained deterministic autoencoder, the autoencoder being configured to compress sample data representing objects and subsequently to reconstruct the sample data again, and wherein the autoencoder is further configured to generate data representing additional objects, the autoencoder being trained by:
providing training data representing objects, and
training the autoencoder bases on the training data, wherein the training of the autoencoder takes place based on a probability distribution and a loss function, and wherein the loss function has a reconstruction term and a regularization term; and
generating data representing further objects uthe using the autoencoder.

6. The method according to claim 5, further comprising the following step:
optimizing the generated data such that the objects represented in the generated data match in at least one property.

7. A controller configured to train a deterministic autoencoder, wherein the autoencoder is configured to compress sample data representing objects and subsequently to reconstruct the sample data again, wherein the autoencoder is further configured to generate data representing additional objects, the controller comprising:
a receiving unit configured to receive training data representing objects; and
a training unit configured to train the autoencoder based on the training data, wherein the training unit is configured to train the autoencoder based on a probability function and a loss function, and wherein the loss function has a reconstruction term and a regularization term.

8. The controller according to claim 7, further comprising:
a weighting unit configured to weight the reconstruction term and the regularization term;
wherein the training unit is configured to train the autoencoder based on the probability distribution, the loss function, and the weightings of the reconstruction term and of the regularization term.

9. The controller according to claim 7, wherein the probability distribution is a Gaussian mixture model.

10. The controller according to claim 7, wherein the training data are sensor data.

11. A controller configured to generate data representing further objects using a deterministic autoencoder, the controller comprising:
a receiving unit configured to receive a deterministic autoencoder trained by a controller configured to train the deterministic autoencoder, the autoencoder being configured to compress sample data representing objects and subsequently to reconstruct the sample data again, wherein the autoencoder is further configured to generate data representing additional objects, the controller configured to train the autoencoder including:
a receiving unit configured to receive training data representing objects, and
a training unit configured to train the autoencoder based on the training data, wherein the training unit is configured to train the autoencoder based on a probability function and a loss function, and wherein the loss function has a reconstruction term and a regularization term; and
a generating unit configured to generate data representing further objects using the autoencoder.

12. The controller according to claim 11, wherein the generating unit includes an optimizing unit configured to optimize the generated data such that the objects represented in the generated data match in at least one property.

13. A non-transitory computer-readable data carrier on which is stored having program code of a computer program for training a deterministic autoencoder, wherein the autoencoder is configured to compress sample data representing objects and subsequently to reconstruct the sample data again, and wherein the autoencoder is further configured to generate data representing additional objects, the program code, when executed by a computer, causing the computer to perform the following steps:
providing training data representing objects; and
training the autoencoder bases on the training data, wherein the training of the autoencoder takes place based on a probability distribution and a loss function, and wherein the loss function has a reconstruction term and a regularization term.
